(19) United States
(12) Patent Application Publication
(10) Pub. No.: US 2017/0248279 A1
(43) Pub. Date: Aug. 31, 2017

(54) Stacked Pipe Light Emitting Diode Lighting Fixture

(71) Applicant: Gelica Optical Systems Corporation, New Taipei City (TW)

(72) Inventors: Walter Dow WU, New Taipei City (TW); Chih Ming YEN, New Taipei City (TW); Shih Che CHEN, New Taipei City (TW)

(21) Appl. No.: 15/054,092

(22) Filed: Feb. 25, 2016

(51) Int. Cl. F21K 9/275; F21V 23/04; F21K 9/272; F21V 29/70; F21V 7/00; F21V 8/00; F21V 23/06

(52) U.S. Cl. CPC F21K 9/275; G02B 6/0096; F21V 23/04; F21V 23/06; F21V 29/70; F21V 7/00; F21K 9/272; F21Y 2115/10

(57) ABSTRACT

A stacked pipe light emitting diode lighting fixture with uniform and uninterrupted emitted light is disclosed. The stacked pipe light emitting diode lighting fixture comprises a plurality of transparent light pipes disposed in a housing. A light emitting diode module is connected to a light receiving end of each light pipe. The light pipes and connected light emitting diode modules are positioned so that light reflecting ends of the light pipes overlap the light emitting diode modules. As a result, the emitted light is uniform in intensity and uninterrupted for one end of the stacked pipe light emitting diode lighting fixture to the other end of the stacked pipe light emitting diode lighting fixture.

### BACKGROUND OF THE INVENTION

Field of the Invention

The present invention relates to lighting devices. More specifically, the present invention discloses a light emitting diode lighting fixture comprising a plurality of transparent light pipes in a stacked orientation to provide an uninterrupted linear light source with superior uniformity of emitted light.

Description of the Prior Art

Conventional fluorescent lights consist of one or two fluorescent tubes mounted in a frame. The sealed glass fluorescent tube contains a small amount of mercury and inert gas with a phosphor powder coating on the inside of the glass tube. When alternating current is applied to electrodes on both ends of the tube electrons migrate through the gas from one end of the tube to the other and the liquid mercury turns into a gas. Electrons in mercury atoms release light photons in the ultraviolet wavelength range which are not visible to humans so the phosphor coating is used to release photons of a lower energy and convert the ultraviolet light into visible light.

A ballast is required in order to control current flow through the fluorescent tube. Without the ballast the fluorescent tube would rapidly be destroyed.

However, the ballast takes up physical space in the fluorescent light making the frame larger.

Additionally, two pin contacts and other tube components are required on both ends of the fluorescent tubes in order for the tube to illuminate. This extends the length of the tube and the amount of non-illuminated sections on both ends of the tube.

As a result, when two conventional fluorescent lights are positioned end to end there is a gap in the emitted light between the two lights. This deficiency of light uniformity produces an inferior quality of emitted light.

The conventional fluorescent light has additional disadvantages. The ballast used to slow down changes in the current by modulating the current at a low cycle rate causes the light to flicker which can cause headaches, eye strain, and general eye discomfort.

Additionally, fluorescent light tubes contain a small quantity of mercury and some ballasts contain carcinogens that can be harmful to the environment and to human health. This makes proper disposal of the conventional fluorescent light expensive and potentially dangerous to humans and damaging to the environment.

Therefore, there is need for an efficient lighting fixture that emits an uninterrupted linear light with superior uniformity of emitted light and is safe for humans and the environment.

### SUMMARY OF THE INVENTION

To achieve these and other advantages and in order to overcome the disadvantages of the conventional method in accordance with the purpose of the invention as embodied and broadly described herein, the present invention provides a stacked pipe light emitting diode (LED) lighting fixture that emits an uninterrupted linear light of superior light uniformity quality.

The stacked pipe LED lighting fixture of the present invention comprises a plurality of light pipes and each light pipe comprises a light receiving end and a light reflecting end. A plurality of light emitting diode modules is provided with one light emitting diode module attached to the light receiving end of each light pipe. The plurality of light pipes and the connected plurality of light emitting diode modules are disposed inside a housing with each light emitting diode module overlapping the light reflecting end of an adjacent light pipe.

Each LED module comprises at least one LED and power contacts. Heatsinks disposed next to the at least one LED are provided for dissipating heat generated by the LED(s). The power contacts are electrically coupled to the LED(s) to allow power to be provided to the LED(s). When electrical power is supplied to the power contacts the LED(s) emit light.

The light pipes comprise elongated transparent or semitransparent material. When the LEDs emit light the light passes through the light receiving end of the connected light pipe, travels through the light pipe, is reflected by reflecting surfaces of the housing, and is emitted from the light pipe to provide a linear light source.

Since the light reflecting ends of the light pipes overlap the LED modules, the emitted light is uninterrupted from one end of the stacked pipe LED lighting fixture to the other end of the stacked pipe LED lighting fixture.

As a result, the stacked pipe LED lighting fixture of the present invention provides and emitted linear light of uniform brightness and superior light quality.

These and other objectives of the present invention will become obvious to those of ordinary skill in the art after reading the following detailed description of preferred embodiments.

It is to be understood that both the foregoing general description and the following detailed description are exemplary, and are intended to provide further explanation of the invention as claimed.

### BRIEF DESCRIPTION OF THE DRAWINGS

The accompanying drawings are included to provide a further understanding of the invention, and are incorporated in and constitute a part of this specification. The drawings illustrate embodiments of the invention and, together with the description, serve to explain the principles of the invention. In the drawings:

FIG. 1 is an isometric view drawing illustrating a stacked pipe light emitting diode lighting fixture according to an embodiment of the present invention;

FIG. 2 is a top view drawing illustrating a stacked pipe light emitting diode lighting fixture according to an embodiment of the present invention;

FIG. 3 is a side view drawing illustrating a stacked pipe light emitting diode lighting fixture according to an embodiment of the present invention;

FIG. 4 is a bottom view drawing illustrating a stacked pipe light emitting diode lighting fixture according to an embodiment of the present invention;

FIG. 5 is an end view drawing illustrating a stacked pipe light emitting diode lighting fixture according to an embodiment of the present invention;

FIG. 6 is an end view drawing illustrating a stacked pipe light emitting diode lighting fixture according to an embodiment of the present invention;

FIG. 7A is a drawing illustrating a test fixture for determining lighting measurements;

FIG. 7B is a drawing illustrating a test fixture and device under test for determining lighting measurements;

FIG. 7C is a table illustrating lighting measurements from the backsplash vertical surface of the test fixture of FIGS. 7A and 7B;

FIG. 7D is a graph illustrating lighting measurements from the backsplash vertical surface of the test fixture of FIGS. 7A and 7B;

FIG. 7E is a table illustrating lighting measurements from the counter surface of the test fixture of FIGS. 7A and 7B;

FIG. 7F is a graph illustrating lighting measurements from the counter surface of the test fixture of FIGS. 7A and 7B;

FIG. 7G is a table illustrating lighting measurements from the backsplash vertical surface of the test fixture of FIGS. 7A and 7B;

FIG. 7H is a graph illustrating lighting measurements from the backsplash vertical surface of the test fixture of FIGS. 7A and 7B;

FIG. 7I is a table illustrating lighting measurements from the counter surface of the test fixture of FIGS. 7A and 7B;

FIG. 7J is a graph illustrating lighting measurements from the counter surface of the test fixture of FIGS. 7A and 7B;

FIG. 8A is a drawing illustrating a test fixture for determining lighting measurements;

FIG. 8B is a drawing illustrating a test fixture and device under test for determining lighting measurements;

FIG. 8C is a table illustrating lighting measurements from the backsplash vertical surface of the test fixture of FIGS. 8A and 8B;

FIG. 8D is a graph illustrating lighting measurements from the backsplash vertical surface of the test fixture of FIGS. 8A and 8B;

FIG. 8E is a table illustrating lighting measurements from the counter surface of the test fixture of FIGS. 8A and 8B; and

FIG. 8F is a graph illustrating lighting measurements from the counter surface of the test fixture of FIGS. 8A and 8B.

### DESCRIPTION OF THE PREFERRED EMBODIMENTS

Reference will now be made in detail to the preferred embodiments of the present invention, examples of which are illustrated in the accompanying drawings. Wherever possible, the same reference numbers are used in the drawings and the description to refer to the same or like parts.

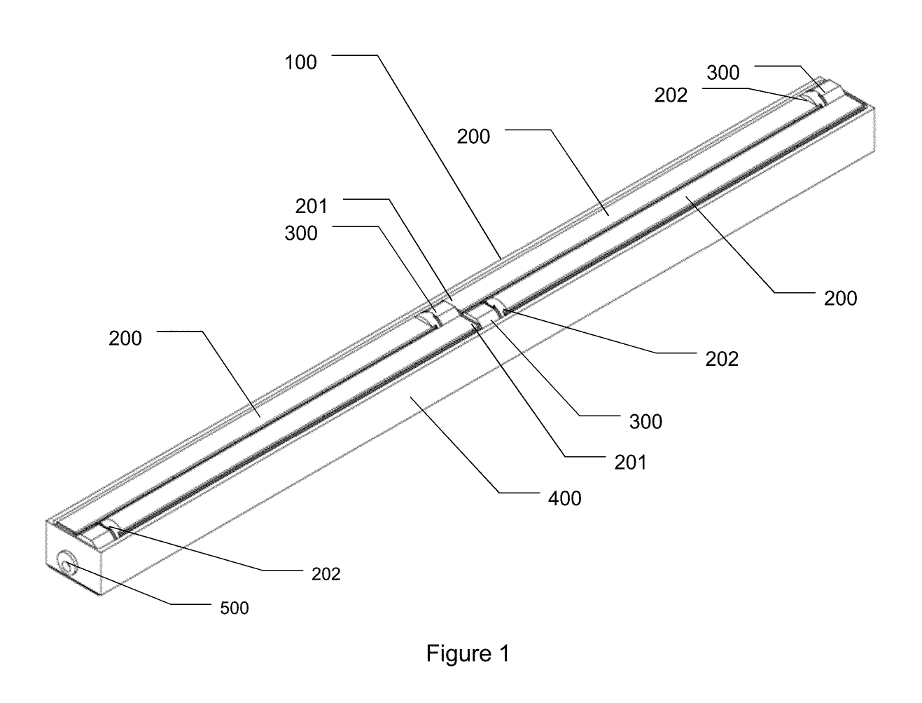

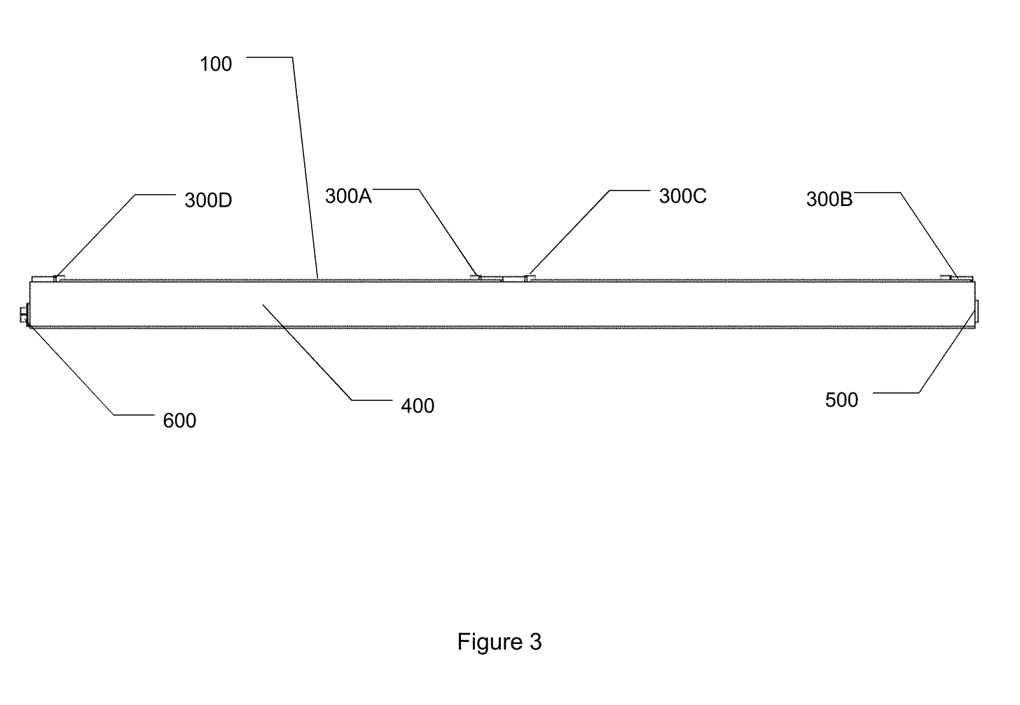

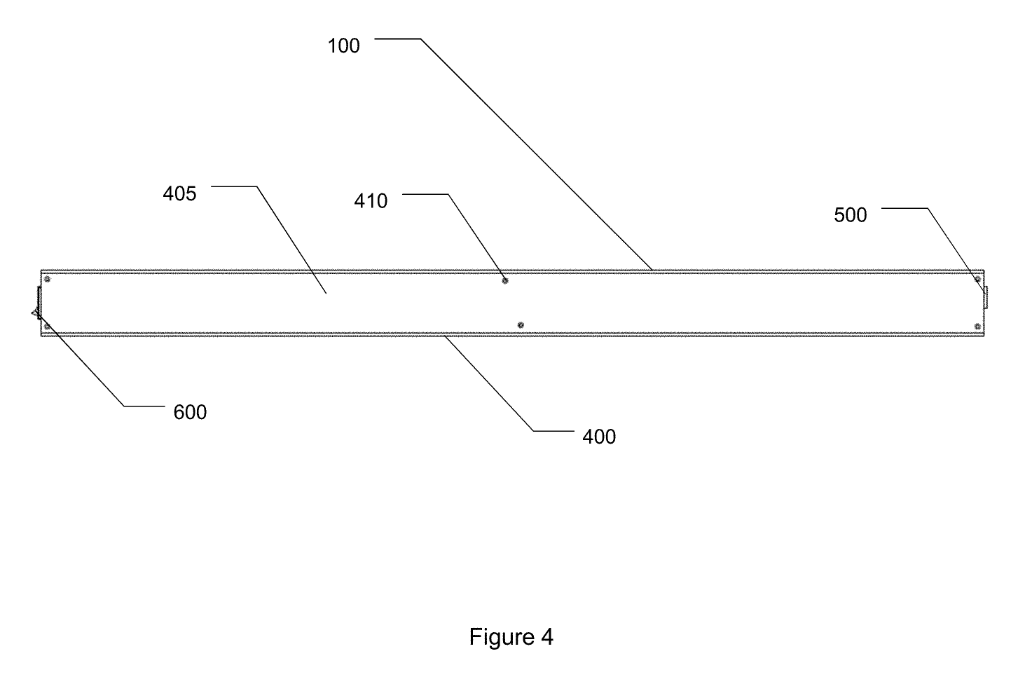

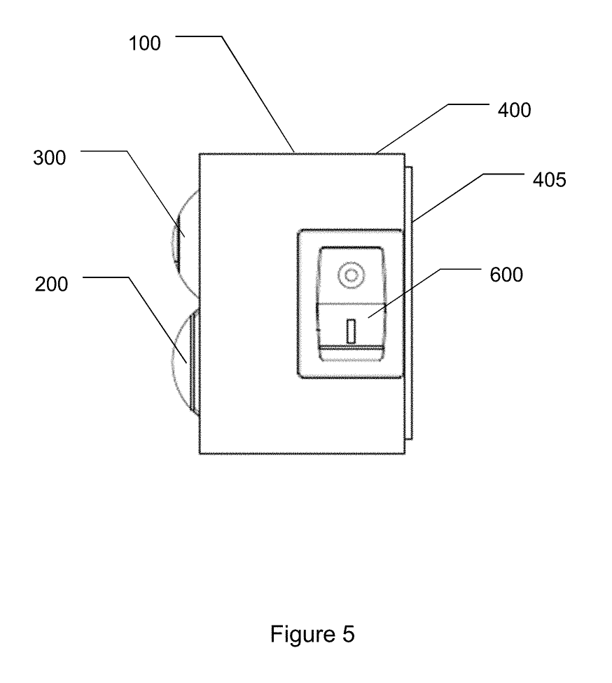

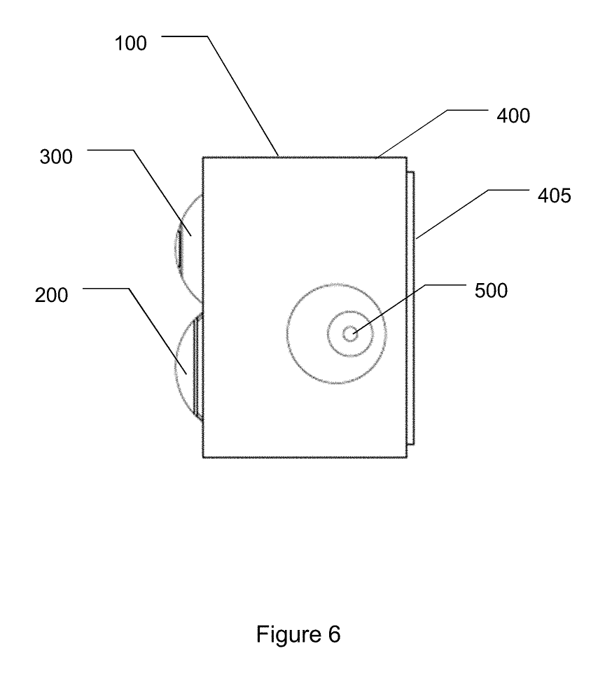

Refer to FIGS. 1-6, which are drawings illustrating a stacked pipe light emitting diode lighting fixture according to an embodiment of the present invention;

The stacked pipe light emitting diode (LED) lighting fixture 100 of the present invention comprises a housing 400, a plurality of light pipes 200, a plurality of LED modules 300, a power connector 500, and a power switch 600.

Each of the plurality of light pipes 200 comprises a light reflecting end 201 and a light receiving end 202. One LED module 300 is connected to the light receiving end 202 of each light pipe 200.

The power switch 600 is provided to turn the stacked pipe LED lighting fixture 100 on and off.

The power connector 500 is provided to supply power to the stacked pipe LED lighting fixture 100 or to another stacked pipe LED lighting fixture 100. For example, a power cord is connected to the power connector 500 to provide power to the stacked pipe LED lighting fixture 100. Or, for example, the power connector 500 of a first stacked pipe LED lighting fixture 100 is connected to an abutting second stacked pipe LED lighting fixture 100 so that the two stacked pipe LED lighting fixtures share the same power source. In this way a number of stacked pipe LED lighting fixtures 100 can be electrically connected together by the power connectors 500 to form a string of light fixtures controlled by one power switch 600.

In another embodiment of the present invention both ends of the stacked pipe LED lighting fixture 100 comprise power connectors 500 to connect with other stacked pipe LED lighting fixtures 100.

An LED module 300 is disposed on the light receiving end of each of the light pipes 200. Each LED module 300 comprises at least one LED, a heatsink, and power contacts. When electrical power is applied to the power contacts, the at least one LED that is coupled to the power contacts emits light.

When the at least one LED emits light, the light from the LED module 300 enters the light pipe 200 via the light receiving end 202 of the light pipe 200. The light travels through the light pipe 200 and exits the light pipe 200 to produce a linear light source. The sides and back of the housing 400 act as a reflector to reflect light emitted by the light pipe 200 to increase light intensity. Additionally, light is reflected back into the light pipe 200 by the light reflecting end 201 of the light pipe 200.

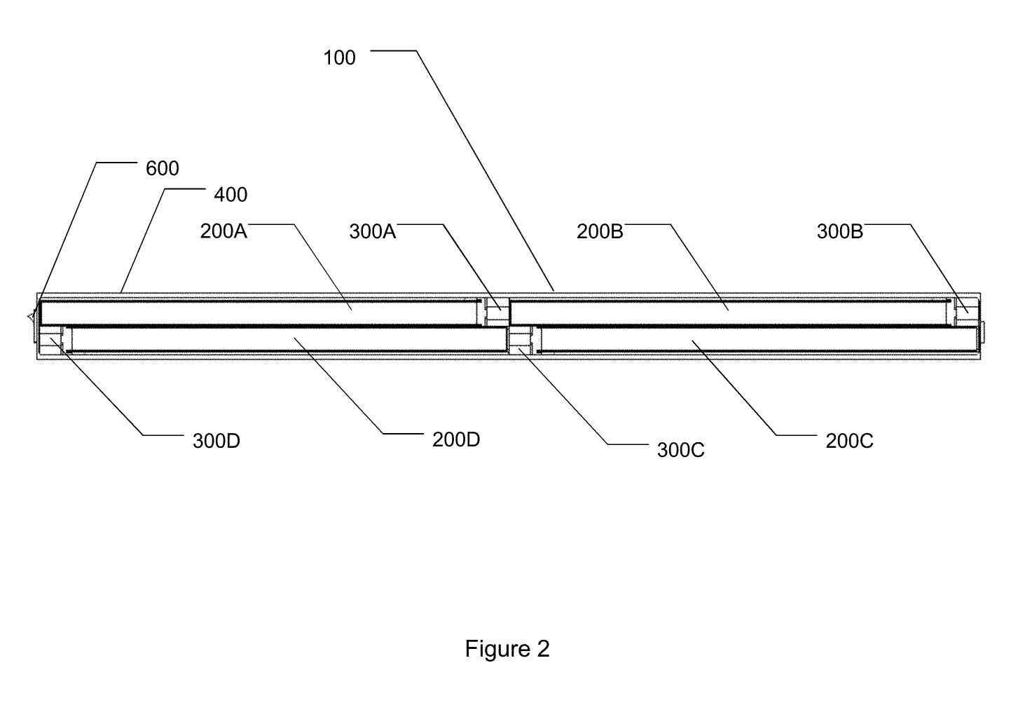

In the embodiment illustrated in FIG. 2 the stacked pipe LED lighting fixture 100 comprises four light pipes 200 and four LED modules 300. LED module 300A is connected to light pipe 200A, LED module 300B is connected to light pipe 200B, LED module 300C is connected to light pipe 200C, and LED module 300D is connected to light pipe 200D.

Light pipe 200A and light pipe 200B are positioned in a row and light pipe 200C and light piped 200D are positioned in a row adjacent. The two rows of light pipes are oriented 180 degrees in relationship to each other. LED module 300D of light pipe 200D is adjacent to the end of light pipe 200A which overlaps LED module 300D. LED module 300C of light pipe 200C is adjacent to the end of light pipe 200B which overlaps LED module 300C. LED module 300B of light pipe 200B is adjacent to the end of light pipe 200C which overlaps LED module 300B. LED module 300A of light pipe 200A is adjacent to the end of light pipe 200D which overlaps LED module 300A.

The ends of the light pipes 200A-200D emit light in areas where the LED modules 300A-300D are positioned. The overlapping stacked pipe positioning of the light pipes 200A-200D allows the stacked pipe LED lighting fixture 100 to emit an uninterrupted linear light from end to end of the stacked pipe LED lighting fixture 100.

In another embodiment of the present invention the stacked pipe LED lighting fixture comprises two light pipes 200 with the LED modules 300 positioned next to the light reflecting end 201 of the adjacent light pipe 200 with the light reflecting ends 201 overlapping the LED modules 300.

A plurality of mounting holes 410 is provided on the housing base 405 for mounting the stacked pipe LED lighting fixture 100 to a surface such as, for example, a cabinet, a shelf, a ceiling, or a wall.

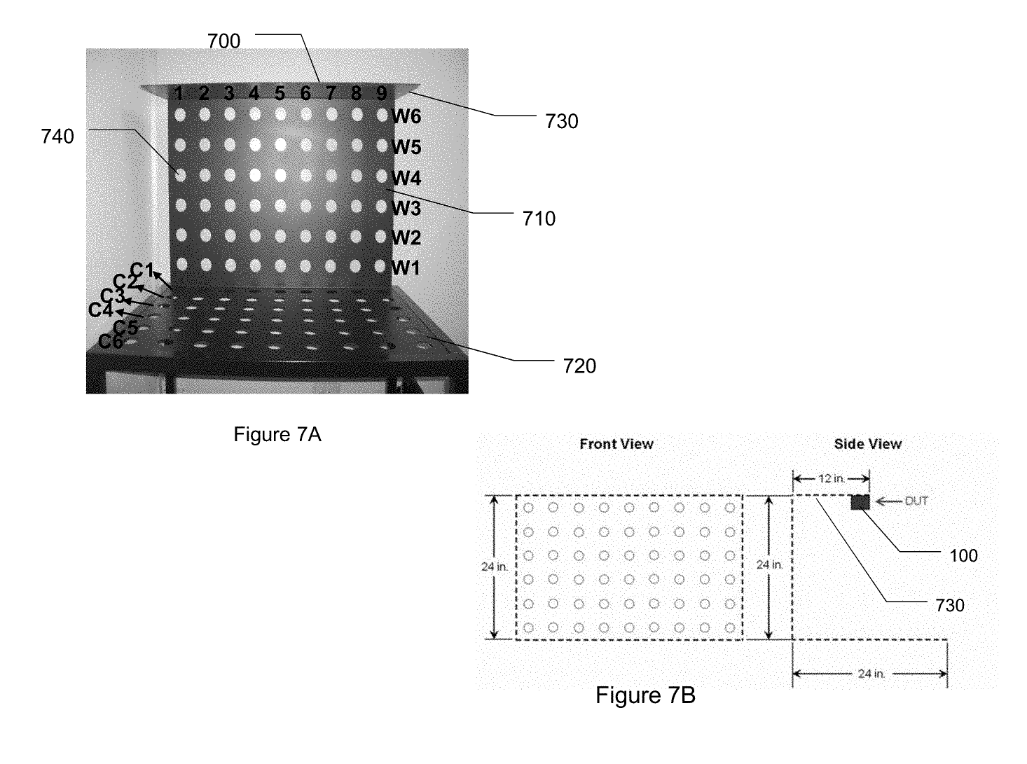

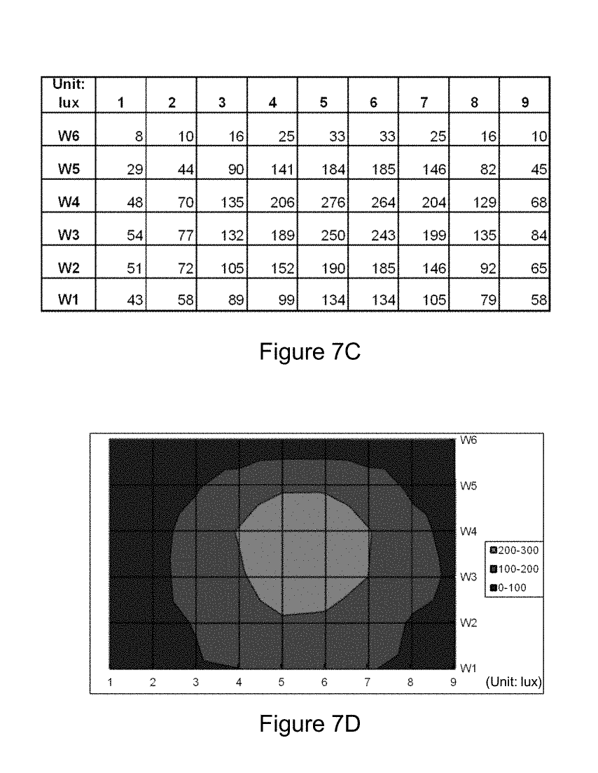

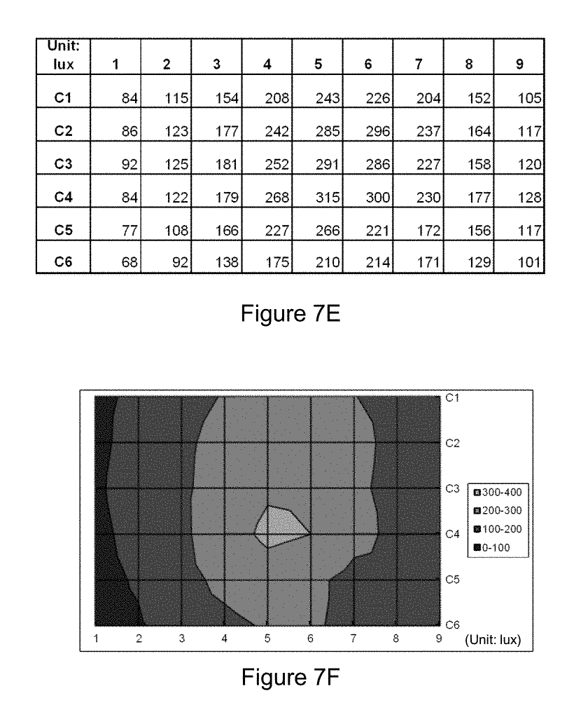

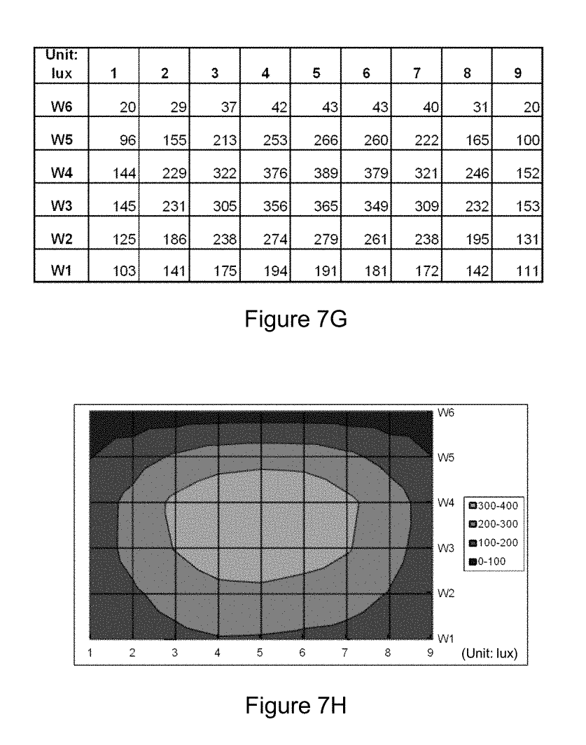

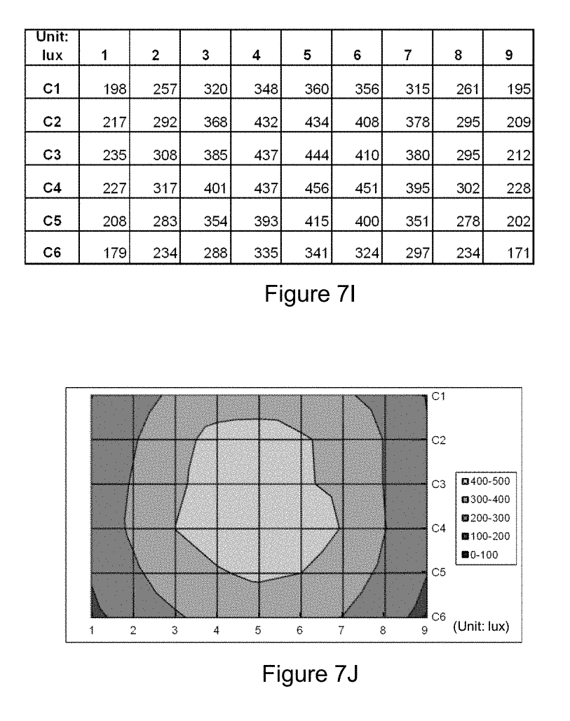

Refer to FIG. 7A, which is a drawing illustrating a test fixture for determining lighting measurements and to FIG. 7B, which is a drawing illustrating a test fixture and device under test for determining lighting measurements.

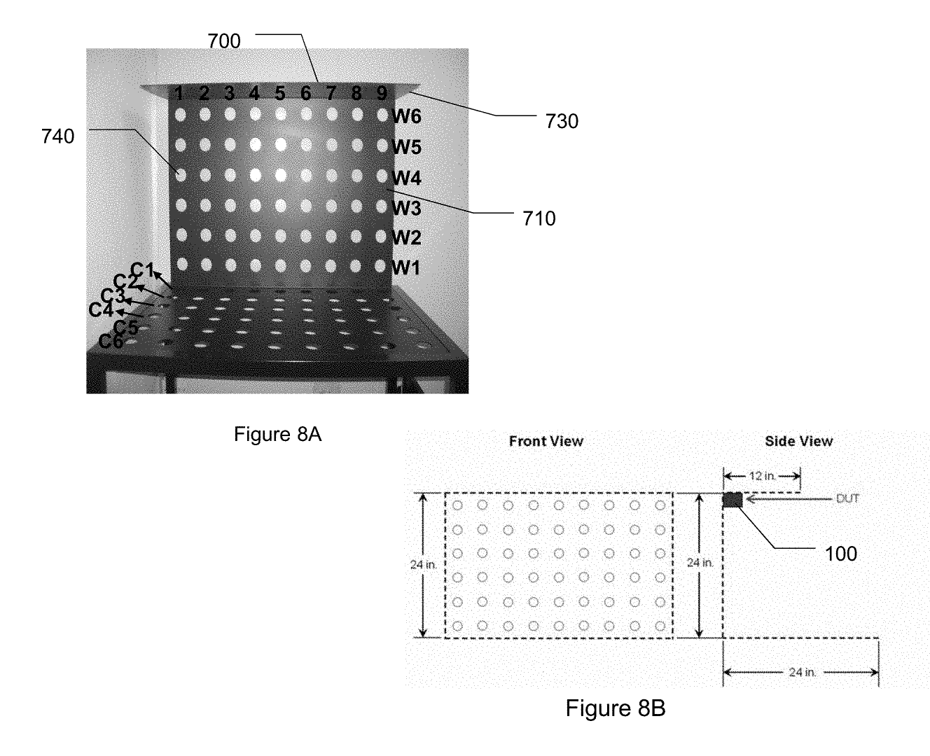

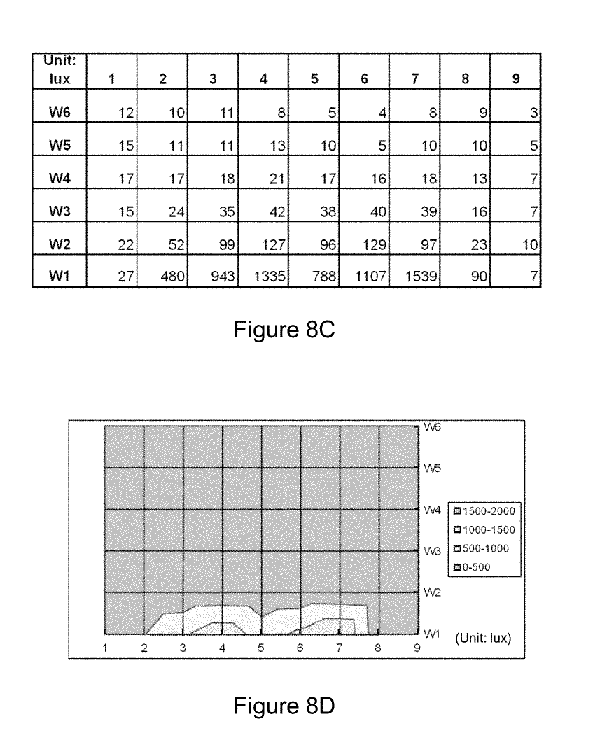

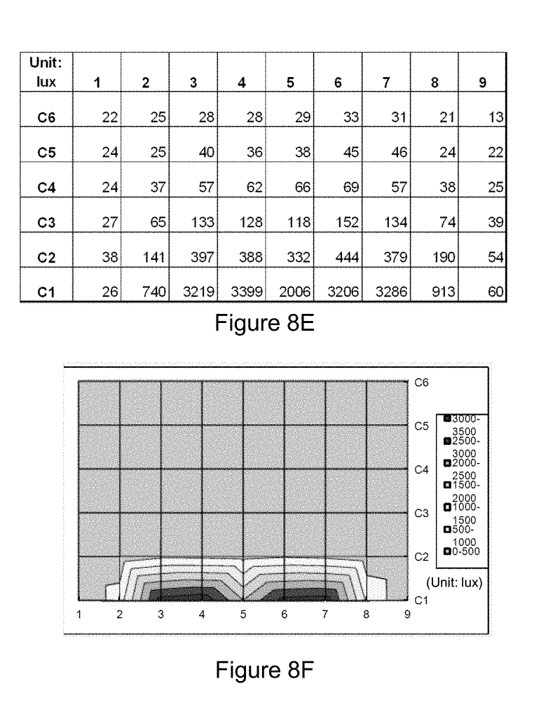

To illustrate the superior performance of the stacked pipe LED lighting fixture of the present invention actual testing results are shown in FIGS. 7C-7J and 8C-8F.

The test equipment used to obtain the Lux measurements was a Gigahertz-Optik Lux Meter.

The test fixture 700 used was a standing table comprising a backsplash 710 vertical panel disposed between a top cover 730 representing a cabinet bottom and a counter surface 720.

A plurality of holes 740 are disposed in the backsplash 710 and the counter surface 720. In the backsplash 710 the holes 740 comprise a grid of 9 holes horizontally (x-axis) labeled 1-9 and 6 holes vertically (y-axis) labeled W1-W6. In the counter surface 720 the holes 740 comprise a grid of 9 holes horizontally (x-axis) labeled 1-9 and 6 holes in depth (z-axis) labeled C1-C6. Holes 1-9 of C1 and holes 1-9 of W1 are closest to the joining of the counter surface 720 and the backsplash 710.

Lux measurements were taken behind and under the test fixture 700 behind the holes 740.

The device under test was a stacked pipe LED lighting fixture 100 of the present invention and positioned on the underside of the outer edge of the top cover 730 to represent an under-cabinet condition where the lighting fixture 100 is installed under a cabinet.

Refer to FIG. 7C, which is a table illustrating lighting measurements from the backsplash vertical surface of the test fixture of FIGS. 7A and 7B, and to FIG. 7D, which is a graph illustrating lighting measurements from the backsplash vertical surface of the test fixture of FIGS. 7A and 7B.

Also refer to Refer to FIG. 7E, which is a table illustrating lighting measurements from the counter surface of the test fixture of FIGS. 7A and 7B, and to FIG. 7F, which is a graph illustrating lighting measurements from the counter surface of the test fixture of FIGS. 7A and 7B.

The device under test was a one foot long 2*Single LED prototype.

As can be seen in the measurements the device under test emitted a uniform light in center of the vertical backsplash and the counter surface.

Refer to FIG. 7G, which is a table illustrating lighting measurements from the backsplash vertical surface of the test fixture of FIGS. 7A and 7B, and to FIG. 7H, which is a graph illustrating lighting measurements from the backsplash vertical surface of the test fixture of FIGS. 7A and 7B.

Also, refer to FIG. 7I, which is a table illustrating lighting measurements from the counter surface of the test fixture of FIGS. 7A and 7B, and to FIG. 7J, which is a graph illustrating lighting measurements from the counter surface of the test fixture of FIGS. 7A and 7B.

The device under test was a one foot long 4*Single LED prototype.

As can be seen in the measurements the device under test emitted a uniform light in center of the vertical backsplash and the counter surface.

Refer to FIG. 8A, which is a drawing illustrating a test fixture for determining lighting measurements and to FIG. 8B, which is a drawing illustrating a test fixture and device under test for determining lighting measurements.

The test fixture 700 was the same test fixture as described in regard to FIGS. 7A and 7B. However, the device under test 100 was positioned at the corner where the top cover 730 meets the vertical backsplash 710 to represent a wall wash condition.

Refer to FIG. 8C, which is a table illustrating lighting measurements from the backsplash vertical surface of the test fixture of FIGS. 8A and 8B, and to FIG. 8D, which is a graph illustrating lighting measurements from the backsplash vertical surface of the test fixture of FIGS. 8A and 8B.

Also, refer to FIG. 8E, which is a table illustrating lighting measurements from the counter surface of the test fixture of FIGS. 8A and 8B, and to FIG. 8F, which is a graph illustrating lighting measurements from the counter surface of the test fixture of FIGS. 8A and 8B.

The device under test was a one foot 2*Single LED prototype stacked pipe LED lighting fixture of the present invention.

As can be seen in the measurements the device under test emitted an extremely uniform light from W6 to W2 and from C6 to C2. Only a slight variation in light intensity was detected at the outer edges of the test fixture away from the device under test.

As described the stacked pipe LED lighting fixture of the present invention provides an emitted linear light with uniform brightness. Since the light reflecting ends of the light pipes overlap the LED modules, the emitted light is uninterrupted from one end of the stacked pipe LED lighting fixture to the other end of the stacked pipe LED lighting fixture.

It will be apparent to those skilled in the art that various modifications and variations can be made to the present invention without departing from the scope or spirit of the invention. In view of the foregoing, it is intended that the present invention cover modifications and variations of this invention provided they fall within the scope of the invention and its equivalent.

What is claimed is:

1. A linear lighting fixture comprising:
a plurality of light pipes, each light pipe comprising:
a light receiving end; and
a light reflecting end;
a plurality of light emitting diode modules, one light emitting diode module attached to the light receiving end of each light pipe; and
a housing, the plurality of light pipes and the plurality of light emitting diode modules disposed inside the housing, each light emitting diode module overlapping the light reflecting end of an adjacent light pipe.

2. The linear lighting fixture of claim 1, further comprising:
the plurality of light pipes comprising:
a first light pipe; and
a second light pipe;
the plurality of light emitting diode modules comprising:
a first light emitting diode module connected to the first light pipe; and
a second light emitting diode module connected to the second light pipe; and
wherein the first light pipe and the second light pipe are positioned in parallel with the first light emitting diode module overlapping the light reflecting end of the second light pipe and the second light emitting diode module overlapping the light reflecting end of the first light pipe.

3. The linear lighting fixture of claim 1, further comprising:
the plurality of light pipes comprising:
a first light pipe;
a second light pipe;
a third light pipe; and
a fourth light pipe;
the plurality of light emitting diode modules comprising:
a first light emitting diode module connected to the first light pipe;
a second light emitting diode module connected to the second light pipe;
a third light emitting diode module connected to the third light pipe; and
a fourth light emitting diode module connected to the fourth light pipe; and
wherein the first light emitting diode module is positioned abutting the second light pipe's light reflecting end, the third light emitting diode module is positioned abutting the fourth light pipe's light reflecting end, the first light pipe's light reflecting end overlapping the fourth light emitting diode module, the second light pipe's light reflecting end overlapping the third light emitting diode module, the third light pipe's light reflecting end overlapping the second light emitting diode module, and the fourth light pipe's light reflecting end overlapping the first light emitting diode module.

4. The linear lighting fixture of claim 1, each light emitting diode module comprising:
at least one light emitting diode;
a heatsink disposed next to the light emitting diode for dissipating heat generated by the at least one light emitting diode; and
a power contact electrically coupled to the at least one light emitting diode for providing power to the at least one light emitting diode.

5. The linear lighting fixture of claim 1, further comprising:
a power switch disposed on the housing to allow the linear lighting fixture to be turned on and off.

6. The linear lighting fixture of claim 1, further comprising:
a power connector disposed on the housing to allow the linear lighting fixture to be electrically connected to another linear lighting fixture.

7. The linear lighting fixture of claim 1, further comprising:
a plurality of power connectors disposed on the housing to allow the linear lighting fixture to be electrically connected to a plurality of other linear lighting fixtures.

8. The linear lighting fixture of claim 1, the plurality of light pipes comprising an elongated transparent or semitransparent material allowing light emitted by the plurality of light emitting diode modules to travel through and be emitted by the plurality of light pipes.

9. The linear lighting fixture of claim 1, the housing further comprising reflecting surfaces for reflecting light to improve intensity of emitted light.

10. A linear lighting fixture comprising:
a first light pipe; and
a second light pipe;
a first light emitting diode module connected to the first light pipe;
a second light emitting diode module connected to the second light pipe;
a housing for holding the first light pipe, the first light emitting diode module, the second light pipe, and the second light emitting diode module;
wherein the first light pipe and the second light pipe are positioned in parallel with the first light emitting diode module overlapping a second light reflecting end of the second light pipe and the second light emitting diode module overlapping a first light reflecting end of the first light pipe.

11. The linear lighting fixture of claim 10, each light emitting diode module comprising:
at least one light emitting diode;
a heatsink disposed next to the light emitting diode for dissipating heat generated by the at least one light emitting diode; and
a power contact electrically coupled to the at least one light emitting diode for providing power to the at least one light emitting diode.

12. The linear lighting fixture of claim 10, further comprising:
a power switch disposed on the housing to allow the linear lighting fixture to be turned on and off.

13. The linear lighting fixture of claim 10, further comprising:
a power connector disposed on the housing to allow the linear lighting fixture to be electrically connected to another linear lighting fixture.

14. The linear lighting fixture of claim 10, the plurality of light pipes comprising an elongated transparent or semitransparent material allowing light emitted by the plurality of light emitting diode modules to travel through and be emitted by the plurality of light pipes.

15. The linear lighting fixture of claim 10, the housing further comprising reflecting surfaces for reflecting light to improve intensity of emitted light.

16. A linear lighting fixture comprising:
a first light pipe comprising:
a first light receiving end; and
a first light reflecting end;
a second light pipe;
a second light receiving end; and
a second light reflecting end;
a third light pipe;
a third light receiving end; and
a third light reflecting end;
a fourth light pipe;
a fourth light receiving end; and
a fourth light reflecting end;
a first light emitting diode module connected to the first light receiving end;
a second light emitting diode module connected to the second light receiving end;
a third light emitting diode module connected to the third light receiving end;
a fourth light emitting diode module connected to the fourth light receiving end; and
a housing holding the first light pipe, the first light emitting diode module, the second light pipe, the second light emitting diode module, the third light pipe, the third light emitting diode module, the fourth light pipe, and the fourth light emitting diode module;
wherein the first light emitting diode module is positioned abutting the second light reflecting end, the third light emitting diode module is positioned abutting the fourth light reflecting end, the first light reflecting end overlapping the fourth light emitting diode module, the second light reflecting end overlapping the third light emitting diode module, the third light reflecting end overlapping the second light emitting diode module, and the fourth light reflecting end overlapping the first light emitting diode module.

17. The linear lighting fixture of claim 16, each light emitting diode module comprising:
at least one light emitting diode;
a heatsink disposed next to the light emitting diode for dissipating heat generated by the at least one light emitting diode; and
a power contact electrically coupled to the at least one light emitting diode for providing power to the at least one light emitting diode.

18. The linear lighting fixture of claim 16, further comprising:
a power switch disposed on the housing to allow the linear lighting fixture to be turned on and off.

19. The linear light fixture of claim 16, the plurality of light pipes comprising an elongated transparent or semitransparent material allowing light emitted by the plurality of light emitting diode modules to travel through and be emitted by the plurality of light pipes.

20. The linear lighting fixture of claim 16, the housing further comprising reflecting surfaces for reflecting light to improve intensity of emitted light.
